(19) United States
(12) Patent Application Publication
(10) Pub. No.: US 2010/0056969 A1
(43) Pub. Date: Mar. 4, 2010

(54) BANDAGES AND SUBSTITUTES THEREFOR

(76) Inventors: KAREN MARGARET THIELSCHER, Pine Ridge, FL (US); ROBIN OWEN ELLIS, Pine Ridge, FL (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/554,161

(22) Filed: Sep. 4, 2009

Related U.S. Application Data
(60) Provisional application No. 61/094,089, filed on Sep. 4, 2008.

(51) Int. Cl. A61D 9/00

(52) U.S. Cl. 602/23

(57) ABSTRACT

Products performing combined or alternative functions of bandages and boots are detailed. Versions of the products may include a main body with split extensions, each of which may be wrapped independently of the other. The main body is designed to cover the lower leg (or other portion) of a horse (or other animal), with the extensions applied as required to achieve optimal fit. The products may be substantially shorter than conventional lengths of bandages yet nevertheless may cover the same amount of leg as do conventional bandages.

### REFERENCE TO PROVISIONAL APPLICATION

This application is based on, claims priority to, and hereby refers to U.S. Provisional Patent Application Ser. No. 61/094,089, filed Sep. 4, 2008, entitled “Bandage Boot,” the entire contents of which are incorporated herein by this reference.

### FIELD OF THE INVENTION

This invention relates to bandages, and substitutes therefor, for animals and more particularly, although not necessarily exclusively, to equine bandages and boots.

### BACKGROUND OF THE INVENTION

Confirming the adage “no leg, no horse,” legs of horses are among the most important and vulnerable parts of their anatomies. Consequently, horse legs frequently are bandaged for protection when they exercise, are ridden by humans (for pleasure, competition, and otherwise), and are transported, for example. Bandaging of horse legs also may occur to prevent or reduce swelling when horses must stand for extended periods and to treat various injuries horses may have suffered. Bandaging further may occur when applying medication or heat or cold therapies to the legs.

Equestrian bandaging is, however, fraught with danger—both to the horse and to the bandager. Horses can be difficult to tie-up and keep completely still, particularly when a single person is attempting to interact with a horse. Accordingly, the mere act of attempting to apply a bandage to an oft-moving leg is challenging. Moreover, working in close proximity to a moving horse may result in injury to the bandager from being kicked, trodden on, or otherwise contacted by the horse.

Traditional bandages are, furthermore, quite long (typically six to nine feet) and, when wound, difficult for small-handed persons such as women and children to hold. Bandages also are subject to undesired unraveling during the bandaging process, sometimes requiring multiple restarts of the process. Additionally, a partly-unraveled bandage on a skittish horse may itself be dangerous, in that its loose portion could become entangled with the horse (or with the person performing the bandaging), resulting in injury. Bandaging with non-uniform pressure also could result in injuring a horse by restricting circulation through, or movement of, tendons or other sensitive portions of the leg.

Elongated bandages are difficult to wash because of likelihood of entanglement with other bandages or clothing. If containing an integral closure mechanism, such as hook and loop fasteners (Velcro), the bandages additionally may be applied incorrectly (i.e. inside-out), which application may not be immediately noticeable during the bandaging process. Because such an incorrect applicable is unsatisfactory, the bandage must be removed and reapplied.

Alternatives to these elongated bandages exist. Several equine “leg wraps” are commercially available, for example. Typically simply rectangular in shape, these wraps may be covered by conventional bandages or retained in place via Velcro closures or tape. Some wraps purport to contain chemicals that may stimulate healing of injured horses. U.S. Pat. No. 5,107,827 to Boyd, whose contents are incorporated herein in their entirety by this reference, discloses various other substitutes for conventional bandages.

Equine boots also readily exist as possible substitutes (in at least certain circumstances) for the bandages. These boots do not wrap multiply around legs of horses usually but are instead fitted thereon, often being shaped to fit the horses' legs. Boots are used by some to protect legs of horses during exercise, transport, and therapy. However, boots generally are not used to bandage (i.e. wrap around) injured legs of horses.

### SUMMARY OF THE INVENTION

Provided by the present invention are products performing combined functions of bandages and boots while simplifying the bandaging process. The present products thus may substitute for either or both conventional objects concurrently while resolving many of the issues mentioned above. Presently-preferred versions of the invention comprise a single-piece main body with at least two split extensions, each of which may be wrapped independently of the other. The main body is designed to cover the lower leg of a horse, with the extensions applied as required to achieve optimal fit. Preferred structures are substantially shorter than conventional lengths of bandages, thus reducing the risk of entanglement, the application time, and the likelihood those with small hands will have difficulty grasping the product. They nevertheless may cover the same amount of leg as do conventional bandages.

Extensions, further, may be retained in default positions until needed. For example, while the main body of the innovative product is being wrapped about a horse's leg, the extensions may be retained in default, unextended positions by hook-and-loop or other fasteners. Hence, even should a horse move significantly during application of the product, such movement is unlikely to unravel any extension. Further, if one or more extensions need not be wrapped around a leg immediately, it may simply remain retained in its unextended position until needed.

Application of the present invention may occur substantially more quickly than application of conventional products. Typically less than one-half the application time of existing bandages is required to apply the present invention to the leg of a horse, reducing the danger to both the applier and to the horse. Application need not always occur at an angle (as is generally necessary for conventional bandages), and the product—or a mirror-image version thereof—may be fitted about either a left or right leg (of the front or back legs) satisfactorily. Products of the present invention may include pouches or other areas in or on which therapy pads or medications may be placed, and having two or more extensions allows non-uniform tensioning about different portions of a leg in situations where desired.

Multiple extensions, when present, need not be of the same length. Indeed, presently preferred for some versions is that they be of different lengths, as differing parts of a horse's leg have different thicknesses. Both the extensions and the main body may be made of any appropriate material; as long as the material is sufficiently flexible to be wrapped around a body part, it may suffice for present purposes. Softer materials are, however, likely advantageous, as they are less likely to irritate any skin which they may contact. Additionally preferred (although certainly not necessary) are materials that are machine washable, and loosely-woven materials may be used when greater conformance to leg shape is desired.

It thus is an optional, non-exclusive object of the present invention to provide wrapping products for use principally with animals such as, but not necessarily limited to, horses.

It is also an optional, non-exclusive object of the present invention to provide products that may substitute for (or be used in addition to) conventional bandages or boots.

It is an additional optional, non-exclusive object of the present invention to provide products including a main body with split extensions, allowing independent wrapping of different portions of legs.

It is a further optional, non-exclusive object of the present invention to provide products in which any extensions may be retained in default positions until needed.

It is, moreover, an optional, non-exclusive object of the present invention to provide products having extensions of different lengths to accommodate different thicknesses of portions of legs of, for example, horses.

Other objects, features, and advantages of the present invention will be apparent to those skilled in the relevant fields with reference to the remaining text and the drawings of this application.

### BRIEF DESCRIPTION OF THE DRAWINGS

FIG. 1 is a plan view of the exterior surface of a bandage of the present invention intended for use on a left leg of an animal.

FIG. 2 is a plan view of the interior surface of the bandage of FIG. 1.

FIG. 3 is a plan view of the exterior surface of the bandage of FIG. 1 with extensions retained in a default (rolled) position prior to use.

### DETAILED DESCRIPTION

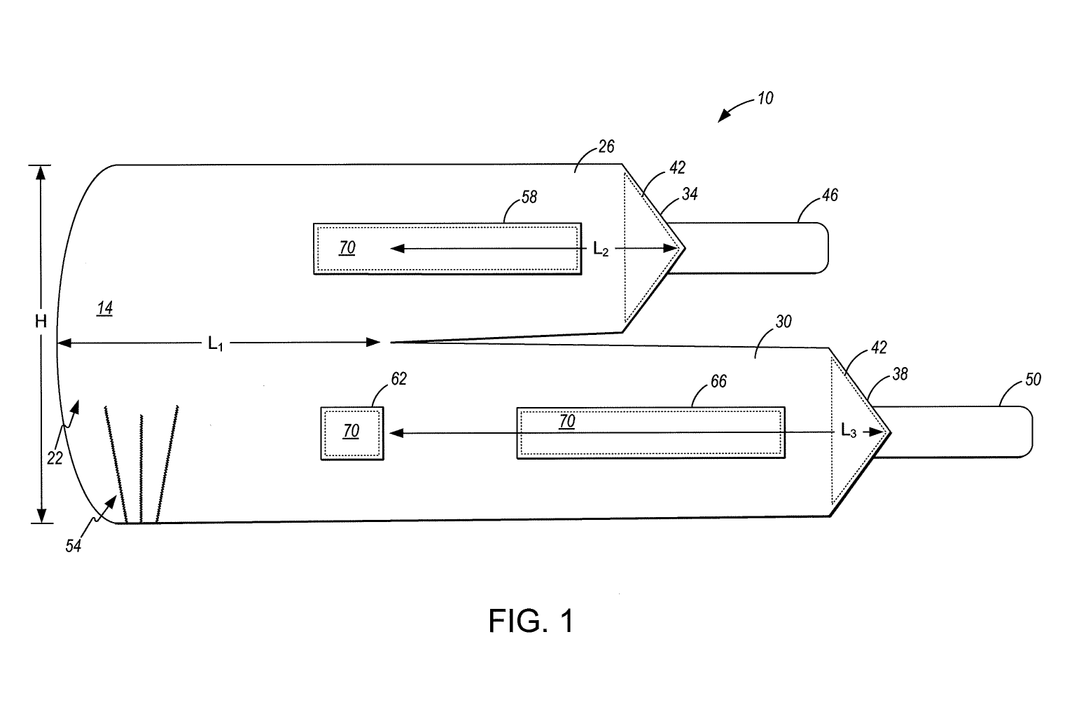

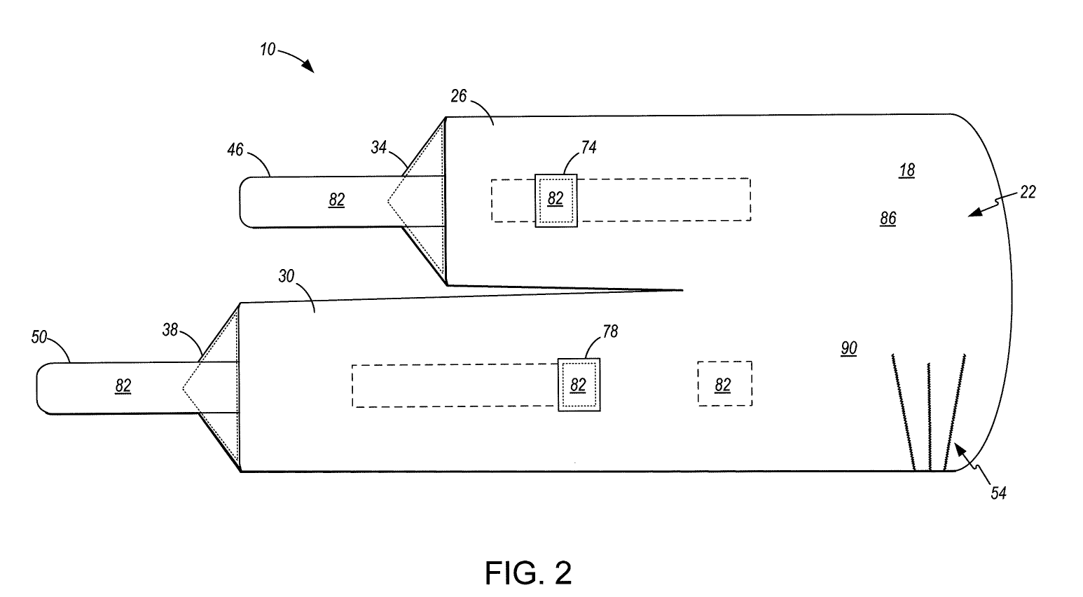

Depicted in FIGS. 1-3 is exemplary bandage 10 of the present invention. Bandage 10 may have exterior surface 14 (FIG. 1) and interior surface 18 (FIG. 2) and comprise main body 22 and extensions 26 and 30. Extensions 26 and 30 preferably are integral with main body 22 but otherwise separate from each other, so each extension 26 or 30 may be moved independently.

In at least certain versions of bandage 10, extension 30 is longer than and positioned below extension 26. Longer, lower extension 30 is intended to be wrapped around the fetlock of a horse, whereas shorter, upper extension 26 is intended to wrapped around the horse's foreleg (which is above and of lesser diameter than the fetlock). Persons skilled in the relevant art will recognize that extensions 26 and 30 may have different lengths as appropriate for the animal or limb about which bandage 10 is to be fitted and indeed conceivably could be sized identically in certain circumstances. Similarly, although two extensions 26 and 30 are depicted in FIGS. 1-3, fewer or greater numbers of extensions may be employed instead. Likewise, although extensions 26 and 30 (when present) preferably are integral with main body 22, other means of connecting or attaching the extensions to the main body may be used.

Extensions 26 and 30 preferably (although not necessarily) are generally rectangular in shape, each terminating in a respective end 34 or 38 which may, but need not necessarily, be triangular. Ends 34 and 38 may be reinforced with thread 42, although such reinforcement is not always required. Extending from end 34 is tongue 46, while extending from end 38 is tongue 50.

Also illustrated in FIGS. 1-3 are darts 54 in a portion of main body 22 adjacent extension 30. Darts 54 may assist in fitting extension 30 snugly about a fetlock. They need not necessarily be present in bandage 10, however, or if present may be located or appear differently than as shown in FIGS. 1-3. Additionally, other aspects of bandage 10 may be modified to facilitate its proper fitting about a particular limb or other region of an animal.

FIG. 1 further details fastening regions 58, 62, and 66 present on exterior surface 14. Each region 58, 62, and 66 preferably includes loops 70 of hook-and-loop (Velcro-type) fasteners, with region 58 sewn onto (or otherwise attached to) extension 26 and regions 62 and 66 sewn onto (or otherwise attached to) extension 30. Regions 58 and 66 preferably are elongated relative to region 62 to accommodate different diameters of limbs, although other relative sizes may be utilized. Although loops 70 are depicted in FIG. 1, in appropriate circumstances any or all of regions 58, 62, and 66 may contain hooks (or even other fasteners) instead.

Assuming loops 70 are present on regions 58, 62, and 66, fastening regions 74 and 78 attached to interior surface 18 may include hooks 82. Tongues 46 and 50, shown in FIG. 2 also as connected to interior surface 18, likewise may include hooks 82. Regions 74 and 78 preferably (although again not necessarily) are approximately the size of region 62 and smaller than regions 58 and 66. Additionally, persons skilled in the appropriate art will understand that any fastening region or tongue illustrated as having hooks 82 may instead have loops 70, in which event complementary fastening regions or tongues will have loops 70 instead of hooks 82.

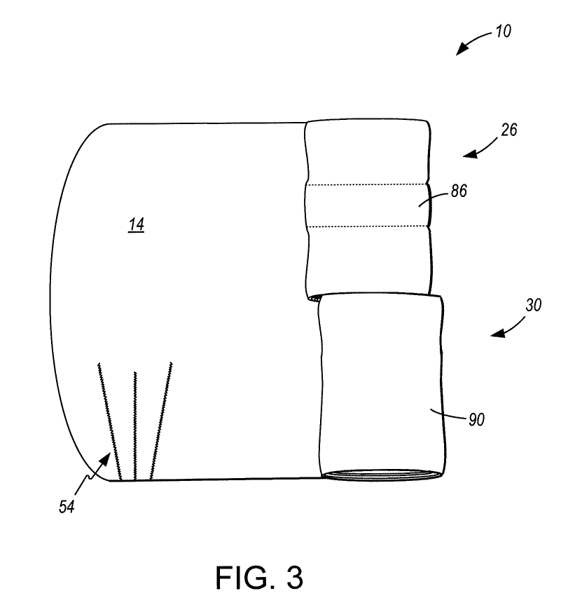

FIG. 3 illustrates bandage 10 with extensions 26 and 30 in their default, pre-use positions. In these positions extensions 26 and 30 are rolled (from right to left in the figures so as to project out of the plane of the paper toward the viewer). Consequently, undersides 86 and 90 of respective extensions 26 and 30 are visible on exterior surface 14.

When extension 26 is fully rolled, hooks 82 of region 74 engage loops 70 of region 58 to fasten extension 26 into its default position. (Earlier in the rolling process, hooks 82 of tongue 46 may engage loops 70 of region 58, allowing extension 26 also to be retained in a partially-rolled position. This intermediate retention is not mandatory, however.)

Similarly, when extension 30 is fully rolled, hooks 82 of region 78 may engage loops 70 of region 62. This engagement retains extension 30 in its default position. (Also possible during the rolling process is that hooks 82 of tongue 50 may engage loops 70 of region 66, although this engagement is not required.)

In use, bandage 10 typically initially is as shown in FIG. 3. Interior surface 18 of main body 22 may be placed in contact with the foreleg of a horse (or in contact with a pre-wrap already around the foreleg), for example, and extension 26 unrolled so as to wrap around the foreleg at least once—and preferably multiple times. Once extension 26 is unrolled, hooks 82 of tongue 46 may engage loops 70 of region 58 to retain extension 26 about the foreleg of the horse. Extension 30 thereafter may be unrolled about the fetlock, with hooks 82 of tongue 50 engaging loops 70 of region 66 to retain extension 30 around the fetlock. Alternatively, extension 30 may be unrolled prior to unrolling of extension 26, or one of the extensions 26 or 30 may remain in its default (rolled) position. Yet alternatively, extensions 26 and 30 may be unrolled so that they slant and overlap to some extent, although no such slant or overlap is necessary with the present invention—unlike conventional use of bandages. These options are possible because of the independence of extensions 26 and 30 as noted above.

Bandage 10 may comprise any suitable materials. Preferably, however, bandage 10 is washable, soft, and flexible. Single- and multi-ply materials are both permissible, as are natural materials and synthetics.

At least one version of bandage 10 for use with horses has a height H of approximately 11.5 inches. In this version the length L₁ of main body 22 is approximately thirteen inches, while respective lengths L₂ and L₃ of extensions 26 and 30 are 11.5 and eighteen inches. These dimensions are provided only as examples, however, as bandage 10 may have any dimensions appropriate for the task to be accomplished. In any event, clear is that bandage 10 may have length significantly shorter than the six to nine feet typically required for conventional bandages. Testing by the applicant has, further, established that bandage 10 may be applied to a horse in approximately twenty seconds, less than one-half the time typically required to apply a conventional bandage.

The foregoing is provided for purposes of illustrating, explaining, and describing embodiments of the present invention. Modifications and adaptations to these embodiments will be apparent to those skilled in the art and may be made without departing from the scope or spirit of the invention.

What is claimed is:

1. A bandage for the limb of an animal, the bandage comprising:
a. a main body;
b. a first extension integral with or connected to the main body and extending generally horizontally therefrom; and
c. a second extension integral with or connected to the main body and extending generally horizontally therefrom.

2. A bandage according to claim 1 in which the first extension is configured to be rolled prior to use, further comprising means for retaining the first extension in a rolled position.

3. A bandage according to claim 2 in which the second extension is configured to be rolled prior to use, further comprising means for retaining the second extension in a rolled position.

4. A bandage according to claim 3 in which the first extension may be rolled independently of the second extension.

5. A bandage according to claim 4 in which the first extension may be unrolled independently of the second extension.

6. A bandage according to claim 5 in which the animal is a horse having a fetlock and the second extension is configured to wrap around the fetlock.

7. A bandage according to claim 6 further comprising means for retaining the second extension in a position wrapped around the fetlock.

8. A bandage according to claim 7 in which the horse also has a foreleg and the first extension is configured to wrap around the foreleg.

9. A bandage according to claim 8 further comprising means for retaining the first extension in a position wrapped around the foreleg.

10. A bandage according to claim 9 in which, when wrapped around the fetlock and foreleg, respectively, the second and first extensions do not overlap.

11. A bandage according to claim 10 in which the first and second extensions are integral with the main body but split from each other.
